(19) United States
(12) Patent Application Publication
(10) Pub. No.: US 2019/0216100 A1
(43) Pub. Date: Jul. 18, 2019

(54) APPARATUS AND METHOD FOR QUICK AND PRECISE DOSING OF WATER

(71) Applicant: Ingen Robotics Pvt. Ltd., Kollam (IN)

(72) Inventors: Rejin NARAYANAN-SAROJA, Kollam (IN); Binus Mohanan THANKAMONY, Kollam (IN)

(21) Appl. No.: 16/246,426

(22) Filed: Jan. 11, 2019

(30) Foreign Application Priority Data
Jan. 12, 2018 (IN) 201841001376

(51) Int. Cl. A21C 14/00; A21D 2/02

(52) U.S. Cl. CPC A21C 14/00; A21B 7/005; A21D 2/02

(57) ABSTRACT

The present disclosure provides an apparatus for dispensing liquid. The apparatus includes a container having an inlet for receiving liquid and an outlet for dispensing liquid. A valve is mounted to the outlet and operable between an opened position and a closed position for regulating flow of the dispensed liquid. A load sensor is adapted to support the container for measuring weight of the container and electronically coupled to control module. The control module is used to control operation of the valve between the opened position and the closed position for dispensing predetermined volume of liquid from the container in a plurality of modes based on readings from the load sensor and predetermined duration of time determined by the control module for dispensing predetermined volume of liquid accurately and precisely.

### CROSS REFERENCE TO RELATED APPLICATIONS

This application claims priority to Indian provisional patent application No. 201841001376, filed Jan. 12, 2018, which is incorporated herein in its entirety by this reference thereto.

### TECHNICAL FIELD

The present disclosure relates to an apparatus and a method for dispensing a liquid and, more particularly, to the apparatus and the method for dispensing the liquid into a flatbread making apparatus.

### BACKGROUND

Liquid dispensing apparatus is known in the art for dispensing a precise volume of a liquid. As such, the liquid dispensing apparatus is generally used in applications where precise dispensing of the liquid is a necessity. One such application, where precise dispensing of the liquid is important is the cooking applications, due to the inherent significance of adding the required ingredients and the liquid in accurate proportions. The advent of modern technologies has allowed incorporation of devices used in the cooking industry in home cooking appliances, for automating food preparation process for the users.

One such home cooking appliance may be a flatbread making apparatus. The flatbread making apparatus generally includes devices for dosing flour, dosing the liquid, kneading the mixture of the flour and the liquid etc., required for making flatbreads such as a chapati, a tortilla, a pita bread, a crepe and the like. As these devices automate the baking process, the quality and the taste of the food prepared may be determined particularly by the correct amount of dosing of the ingredients particularly the liquid for kneading the ingredients. The existing liquid dispensing devices, which are particularly used in the home cooking appliances, are generally complex in construction and operation, expensive, and cumbersome for use in the household applications.

Therefore, there exists a need for techniques for dispensing the liquid, which can overcome one or more limitations stated above in addition to providing other technical advantages.

The information disclosed in this background section is only for enhancement of understanding of the general background of the invention and should not be considered as an acknowledgment that this information forms the prior art already known to a person skilled in the art.

### SUMMARY

Various embodiments of the present disclosure provide an apparatus for dispensing a liquid. The apparatus includes a container for storing the liquid and a control module. The container includes an inlet for receiving the liquid and an outlet for dispensing the liquid. The apparatus also includes a valve mounted to the outlet. The valve is communicably coupled to the control module and operable between an opened position and a closed position for regulating flow of the liquid dispensed through the outlet. Further, a load sensor supports the container and is communicably coupled to the control module. The load sensor is configured to measure weight of the container. The control module is adapted to control operation of the valve between the opened position and the closed position for dispensing a predetermined volume of the liquid from the container in a plurality of modes based on readings obtained from the load sensor and a predetermined duration of time determined by the control module

The present disclosure also provides a flatbread making apparatus. The flatbread apparatus comprising the apparatus for dispensing the liquid, which includes the container for storing the liquid and the control module. The container includes the inlet for receiving the liquid and the outlet for dispensing the liquid. The apparatus also includes the valve mounted to the outlet. The valve is communicably coupled to the control module and operable between the opened position and the closed position for regulating flow of the liquid routed through the outlet. Further, the load sensor is mounted to the container and adapted to support the container for measuring the weight of the container. The load sensor is communicably coupled to the control module. The control module is adapted to control operation of the valve between the opened position and the closed position for dispensing the predetermined volume of the liquid from the container in the plurality of modes, based on the readings obtained from the load sensor and the predetermined duration of time determined by the control module. The flatbread apparatus also includes a mixer unit juxtaposed below the container. The mixer unit is configured to receive the predetermined volume of the liquid dispensed from the container and is adapted to knead the flour with the predetermined volume of liquid for preparing a doughball. A mechanism is included in the flatbread apparatus for baking a flatbread from the doughball received from the mixer unit.

The present disclosure also provides a method for dispensing the liquid. The method includes computing, by the control module, the predetermined volume of the liquid to be dispensed via the plurality of modes, wherein the control module computes the predetermined volume of the liquid, based on the flow rate of the liquid dispensed from the valve of the container, the weight of the container measured by the load sensor. Subsequently, the control module divides the predetermined volume of the liquid to be dispensed into a first portion and a second portion. The control module subsequently operates the valve to the opened position in a time-based mode for the predetermined duration of time for dispensing the first portion and operating the valve to the closed position upon lapse of the predetermined duration of time. The control module computes the predetermined duration of time, based on the flow rate of the liquid dispensed and the weight of the container corresponding to the first portion of the liquid to be dispensed. Further, in a weight-based mode dispensing, the control module, operates the valve between the opened position and the closed position intermittently, for dispensing the second portion, wherein the control module monitors the weight of the container while dispensing sub-portions of the second portion during each intermittent operation of the valve and correspondingly adjusting the intermittent operation of the valve for dispensing the second portion.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers:

FIG. 1A is a simplified perspective view of an apparatus for dispensing a predetermined volume of liquid, in accordance with an exemplary embodiment of the present disclosure;

FIG. 1B is a simplified perspective view of the apparatus of FIG. 1A, in accordance with another exemplary embodiment of the present disclosure;

FIG. 2A is a schematic representation of the apparatus of FIG. 1, illustrating a closed position of the valve, in accordance with an exemplary embodiment of the present disclosure;

FIG. 2B is a schematic representation of the apparatus of FIG. 1, illustrating an opened position of the valve, in accordance with an exemplary embodiment of the present disclosure;

FIG. 3 is a schematic representation of a flatbread apparatus including the apparatus of FIG. 1, in accordance with an exemplary embodiment of the present disclosure; and

FIG. 4 is a flow diagram illustrating a method for dispensing the predetermined volume of liquid from the apparatus, in accordance with an exemplary embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in the embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Various embodiments of the present disclosure provide an apparatus for dispensing a predetermined volume of liquid. The apparatus is configured with a mechanism for dispensing the predetermined volume of the liquid, particularly into a mixer unit of a flatbread apparatus, precisely. The liquid can be of such as, but not limited to water, used for preparing a doughball in the flatbread apparatus.

The apparatus includes a container for storing the liquid. The container includes an opening for receiving the liquid and an outlet for dispensing the liquid. The apparatus also includes a valve mounted to the outlet and electronically coupled to a control module. The valve is operable in between an opened position and a closed position for regulating flow of the liquid, routed through the outlet of the container. The apparatus also includes a load sensor adapted to support the container for measuring weight of the container. The load sensor may also be configured for monitoring level of the liquid within the container, based on the weight of the apparatus measured. The load sensor may provide an indication signal to a user, when the level of the liquid within the container falls below a threshold level. This configuration of the load sensor obviates the need for a level sensor for monitoring the level of the liquid within the container. The apparatus also includes the control module, adapted to control operation of the valve between the opened position and the closed position for dispensing a predetermined volume of the liquid from the container in a plurality of modes based on readings obtained from the load sensor and a predetermined duration of time determined by the control module.

While dispensing the liquid, the control module is configured to compute the predetermined volume of the liquid to be dispensed, and to divide the predetermined volume of the liquid into a first portion and a second portion. The control module is configured to compute the predetermined volume, based on flow rate of the liquid dispensed from the valve, the weight of the container measured by the load sensor. The first portion is dispensed according to a time-based mode of the plurality of modes. In the time-based mode, the first portion is dispensed, by operating the valve to the opened position for the predetermined duration of time and then operating the valve to the closed position upon lapse of the predetermined duration of time. The control module is configured to compute the predetermined duration of time, based on the flow rate of the liquid dispensed and the weight of the container corresponding to the first portion of the liquid required to be dispensed. The second portion is dispensed, according to a weight-based mode of the plurality of modes. In the weight-based mode, the second portion is dispensed by operating the valve between the opened position and the closed position in an intermittent manner. The control module is configured to monitor the weight of container, after dispensing of each sub-portions of the second portion during each intermittent operation of the valve and correspondingly adjust intermittent operation of the valve for dispensing the second portion. This process ensures accurate and precise dispensing of the liquid, without the need for cumbersome time-consuming dispensing processes and complex mechanisms.

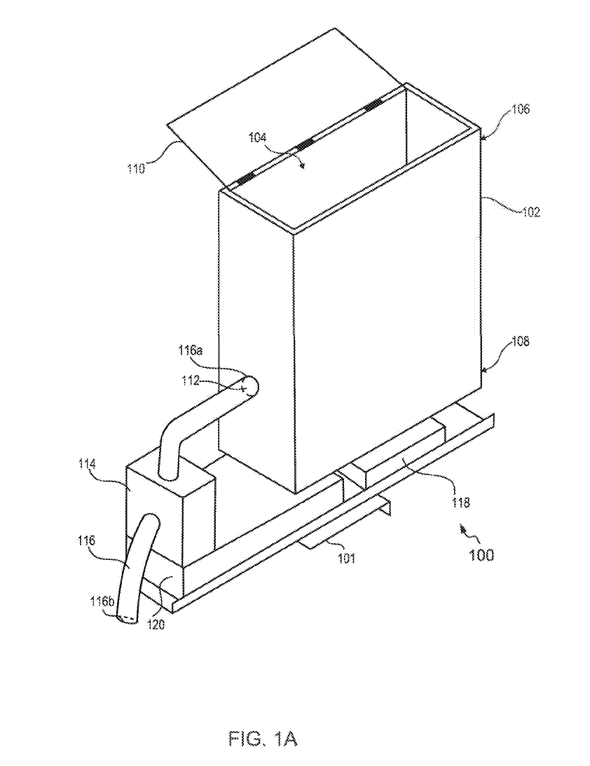

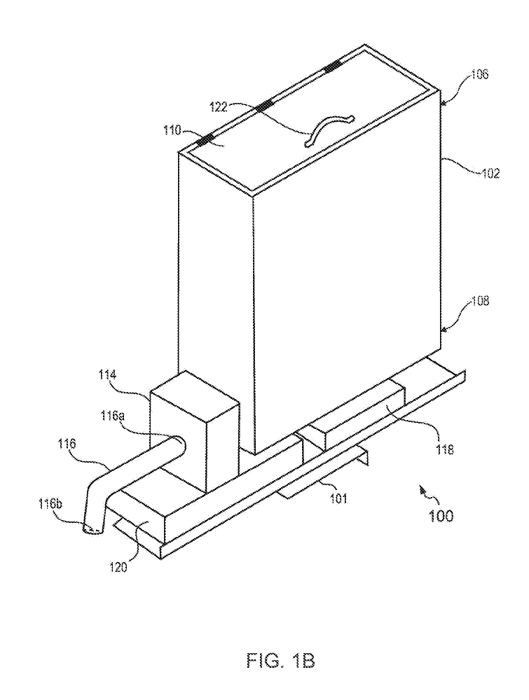

Various embodiments of an apparatus 100 for dispensing a predetermined volume of a liquid are explained below in a detailed manner, herein with reference to FIG. 1A to FIG. 4.

FIGS. 1A and 1B in one exemplary embodiment of the present disclosure illustrate a perspective view of the apparatus 100 for dispensing the predetermined volume of a liquid. The apparatus 100 can be integrated with devices such as an apparatus for making flatbreads, for dispensing the liquid therein. The apparatus 100 is configured to dispense the predetermined volume of the liquid accurately and precisely, without the need for cumbersome time-consuming dispensing processes and complex mechanisms.

The apparatus 100 includes a container 102 mounted on a frame member 101 for storing the liquid. The container 102 includes an inlet 104, preferably provided on a top portion 106 of the container 102, for receiving a predefined volume of the liquid for storing. The predefined volume may be determined based on the application of the apparatus 100. The predefined volume may be a total capacity of the container 102 for storing the liquid. The container 102 is configured with a lid 110, mounted to the inlet 104 or hinged on the top portion 106, for restricting access into the container 102 upon including the liquid therein. The lid 110 also prevents entry of debris or other foreign particles into the container 102, thereby ensuring the sterility of the liquid dispensed from the container 102. The lid 110 may include a handle 122 (for e.g. as shown in FIG. 1B) for ease of operating the lid 110. The container 102 also includes an outlet 112, preferably mounted on a bottom portion 108 of the container 102, for dispensing the liquid from the container 102. The configuration of the outlet 112 may be selected based on the flow rate characteristics required for dispensing the liquid. As an example, the outlet 112 can be selected from one of a corrugated configuration (not shown in Figures), a streamlined configuration (not shown in Figures) and the like as per feasibility. In the corrugated configuration of the outlet 112, the liquid may be dispensed in a turbulent manner and thus, may be characterized by irregularities in flow rates during the dispensing process. In the streamlined configuration of the outlet 112, the liquid may be dispensed in a streamlined manner and would be characterized by uniform flow characteristics during the dispensing process.

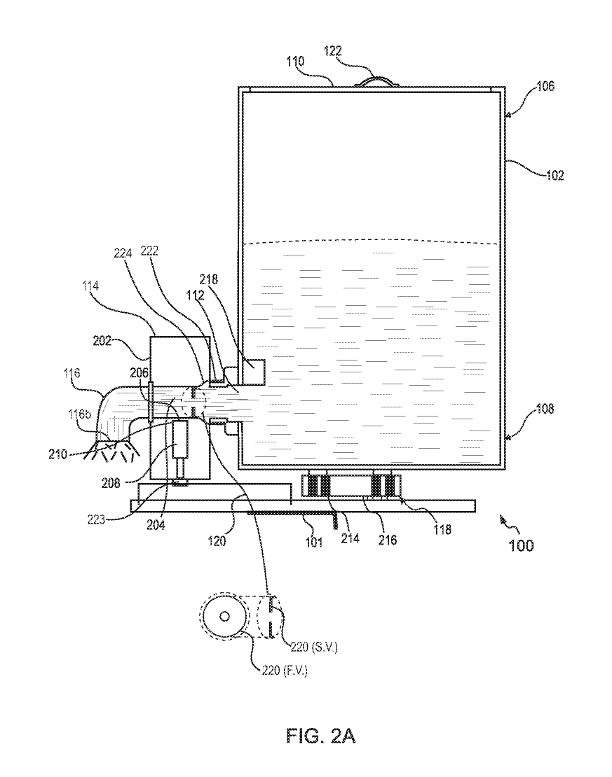

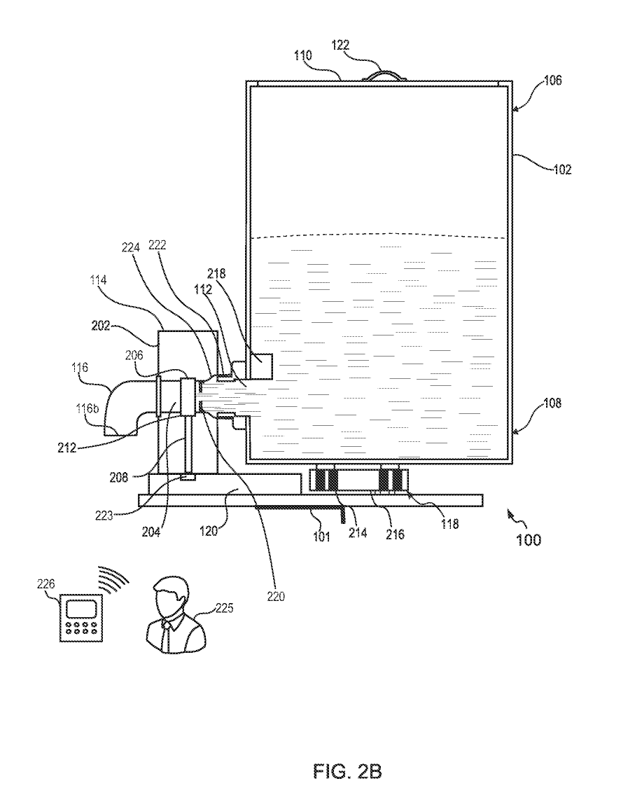

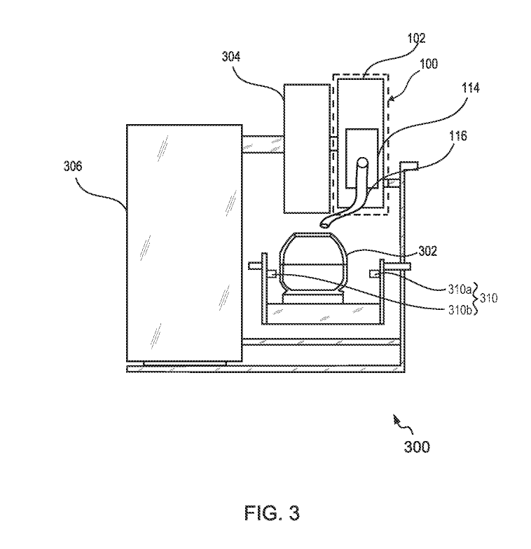

Referring to FIG. 2A in conjunction with FIGS. 1A and 1B, the apparatus 100 further includes a valve 114 mounted to the outlet 112 for regulating the flow of liquid from the container 102. While mounting the valve 114 to the outlet 112 a bulge portion 224 may be formed at the junction 222, due to the larger diameter of the outlet 114. The valve 114 includes a valve body 202 mounted to the outlet 112 and having a channel 204 for routing the liquid dispensed from the outlet 112 of the container 102. A modulating element 206 is disposed within the valve body 202 for modulating or controlling the liquid dispensed. The modulating element 206 may be one of a plug, a globe, a piston, a ball, a disk and the like. An actuator 208 is coupled to the modulating element 206, for operating the modulating element 206 between an opened position 210 (for e.g. as shown in FIG. 2B) and a closed position 212, for controlling the liquid dispensed. The actuator 208 may be operated manually or automatically, for actuating the modulating element 206 and can be selected, based on the type of the modulating element 206 employed in the valve body 202. The actuator 208 may also operate the modulating element 206 intermittently, for varying the size of the channel 204 and thereby varying the dispensing rate of the liquid from the container 102. In an embodiment, the actuator 208 of pneumatic type can be coupled with the modulating element 206 of the piston type directly (for e.g. as shown in FIGS. 2A and 2B). The actuator 208 controls actuation of the piston 206 within the channel 204, for varying the dispensing rate of the liquid. In an embodiment, the actuator 208 of pneumatic type can be coupled with the modulating element 206 of disk type (not shown in figures) via a suitable gear mechanism (not shown in figures), for controlling the liquid dispensed. In an embodiment, the valve 114 may be configured within a tubular member 116 coupled to the outlet 112 for controlling the liquid dispensed from the container 102. In an embodiment, the valve 114 is positioned in between the first end 116a and the second end 116b of the tubular element 116 (as shown in FIG. 1B). The tubular member 116 (for e.g. see in FIG. 1B) includes a first end 116a coupled to the outlet 112 and a second end 116b positioned within a flour container 306, such as the mixer unit 302 of the flatbread apparatus 302 (for e.g. as shown in FIG. 3) to ensure dispensing of the liquid within the mixer unit 302.

In an embodiment, the valve 114 can be selected from one of a directional control valve, a check valve, a plug valve, a ball valve, a butterfly valve, a needle valve, a pinch valve, a pressure relief valve and the like.

In an embodiment, the valve 114 includes a pilot port (not shown in Figures) extending from the valve body 202. The pilot port when in the opened position allows the liquid collected in the tubular member 116 to flow, even when the valve 114 is in the closed position, which may cause over-flow of the liquid during the dispensing operation. Thus, the pilot port is clamped or is maintained in the closed position for preventing overflow of the liquid from the tubular member 116 during the dispensing operation.

In an embodiment, the shape of the container 102 may be selected from one of cylindrical shape, a cubical shape, a rectangular shape or any other shape as per design feasibility and requirement.

In an embodiment, the bulge portion 224 at the junction 222 may increase the flow rate of the liquid from the container 102. Thus, a hollow disc 220 may be provided at the vicinity of the bulge portion 222 for controlling the flow rate of the liquid.

Referring back to FIG. 1, the apparatus 100 further includes a load sensor 118 adapted to support the container 102 for determining the weight of the container 102. The load sensor 118 includes a housing 214 mounted to the frame member 101 and positioned below the container 102. A measuring unit 216 is disposed within the housing 214 and is configured to receive the load of the container 102 via the housing 214, for determining the weight of the container 102. The measuring unit 216 may be one of a strain gauge, a diaphragm, a piston-cylinder arrangement and the like, based on the load sensor 118 considered. The load sensor 118 is electronically coupled to a control module 120 for communicating the determined weight reading determined. In an embodiment, the load sensor 118 is positioned between the frame member 101 and the container 102. In an embodiment, the load sensor 118 is positioned in a central portion along a width of the container 102.

Further, the control module 120 is electronically coupled with the valve 114 for controlling actuation of the valve 114 between the opened position 210 and the closed position 212 in a plurality of modes. The control module 120 controls operation of the valve 114 between the opened position 210 and the closed position 212, for dispensing the predetermined volume of the liquid from the container 102. The dispensing of the predetermined volume of the liquid, by the control module 120, in the plurality of modes is performed, based on the readings received from the load sensor 118 and the predetermined duration of time determined by the control module 120.

The control module 120 may also control the actuation of the valve 114 based on the inputs received from the user such as, ‘dispense 50 ml of liquid’, ‘stop the dispensing operation’, ‘stop the dispensing operation’ and the like. The control module 120 is associated with a peripheral input device (not shown in the Figures) for receiving the input from the user 225. In an embodiment, the control module 120 may receive input from the user via a mobile communication device 226 associated with the user 225.

In an embodiment, the control module 120 monitors the level of the liquid within the container 102 based on the weight measurement readings received from the load sensor 118. The control module 120 may provide an indication signal to the user 225 when the weight of the container 102 determined by the load sensor 118 decreases beyond a threshold weight. The threshold weight is indicative of the level of the liquid within the container 102. Thus, when the weight of the container 102 decreases beyond the threshold weight, the level of the liquid is below a threshold level. The threshold level may be the level of liquid below the level of the outlet 112 of the container 102. This configuration mitigates the need for a separate level sensor in the apparatus 100 for detecting the level of the liquid. In an embodiment, the load sensor 118 is selected from one of a load cell, a strain gauge and the like as per design feasibility and requirement. In an embodiment, the control module 120 may determine the threshold level based on results obtained from the previous iteration of the liquid dispensing operation. In an embodiment, the control module 120 may determine the level of the liquid based on the liquid dispensed while preparing each of the flatbreads in the flatbread apparatus 300.

In an embodiment, the control module 120 is configured to determine the rate of dispensing of the liquid from the container 102, based on the rate of loss of weight of the container 102, while the valve 114 is in the opened position 210.

In an embodiment, the liquid can be dispensed from the outlet 112 due to gravity or, a pump (not shown in the Figures) may be employed in the apparatus 100 for dispensing the liquid.

In an embodiment, the apparatus 100 may include a liquid level sensor 218 for detecting the level of liquid within the container 102 and electronically coupled to the control module 120. The control module 120 may provide the indication signal to the user 225 when the level of the liquid detected by the liquid level sensor 218 is below the threshold level. The liquid level sensor 218 may be an optical sensor, an electromechanical sensor or a mechanical sensor, adapted to determine the level of the liquid within the container 102.

In an embodiment, the control module 120 may include predefined computation values or instructions corresponding to one of the apparatus 100 in which the control module 120 may be mounted, the type of liquid and the like. This configuration of the control module 120 enables operation of the apparatus 100, without the need for trial testing. In an embodiment, the control module 120 may be programmed to control the apparatus 100 installed in a flatbread apparatus 302.

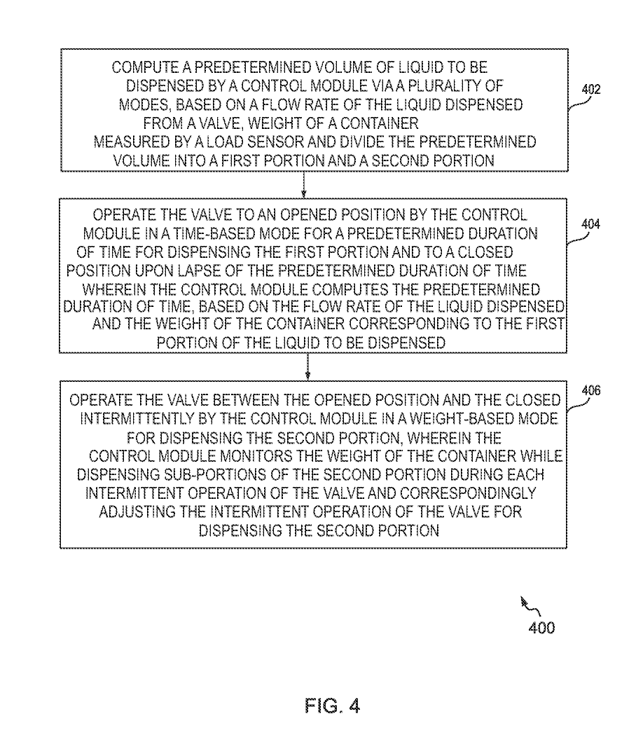

In an embodiment, the control module 120 may perform a trial test for dispensing the predetermined volume of the liquid from the container 102, prior to initiation of the dispensing operation. During the trial test, the control module 120 may operate the valve 114 via the actuator 208 for a predetermined duration of time, for example, for one second. Subsequently, the control module 120 measures the volume of the liquid dispensed during the dispensing process, by measuring a reduction in weight of the container 102 via the load sensor 118. The data obtained during the trial tests are stored within the control module 120, so that the control module 120 may correspondingly operate the apparatus 100 for dispensing the first portion of the predetermined volume accurately, in the time-based mode dispensing (as shown in operation 404, of FIG. 4), based on the inputs received from the user 225.

In another embodiment, the control module 120 may also determine the time required for the liquid particles to discharge from the outlet 112 to the second end 116b of the tubular element, in the first stage of operation of the apparatus 100 upon installation.

In an embodiment, the control module 120 may perform one more trial test, prior to initiation of the dispensing operation. The purpose of the trial test is to determine rate of change of flow rate of the liquid discharged from the channel 204 of the valve 114, corresponding to change in pressure head (or hydraulic head) of the liquid stored in container 102 during dispensing of the liquid. The data obtained during the trial tests are stored within the control module 120, so that the control module 120 may correspondingly operate the apparatus 100 for dispensing the first portion of the predetermined volume accurately, in the time-based mode dispensing, based on the inputs received from the user 225. In an exemplary embodiment, for dispensing the first portion, prior to initiation of the dispensing operation, the control module 120 determines the rate of change of the flow rate of the liquid during dispensing of the first portion and correspondingly calibrate the predetermined duration of time for dispensing the first portion accurately and precisely, based on change of the flow rate of the first portion of the predetermined volume.

In an exemplary embodiment, the control module 120 is configured with pre-defined computational data of patterns of change of the flow rate associated with change of pressure head at various levels of the liquid in the container 102, so that during dispensing of the predetermined volume of the liquid, the control module 120, readily operates the valve 114 for precisely dispensing the required volume of the liquid. In an embodiment, the control module 120 may be manually fed with pre-defined computation data containing the patterns of change of the flow rate based on the different values of the pressure head, for automating the dispensing process of the first portion of the predetermined volume of the liquid.

In an embodiment, the liquid level sensor 218 is configured for determining the volume or pressure head at any intermediate level of the liquid stored in the container 102. The level sensor may be communicably coupled to the control module 120 for communicating the monitored readings. The control module 120 computes the possible flow rate of the liquid based on readings determined by the liquid level sensor 218. The control module 120 operates the valve 114 corresponding to the computed flow rate, for precisely dispensing the required volume of the liquid, during the dispensing process.

In an embodiment, for dispensing the predetermined volume of the liquid, the control module 120 computes the weight of the container 102, corresponding to the predetermined volume of the liquid to be dispensed. The control module 120 based on the computation, operates the valve 114 to the opened position 210 while monitoring the weight of the container 102. The control module 120 operates the valve 114 to the closed position 212 when the weight of the container 102 reaches or corresponds to the weight computed by the control module 120.

In an embodiment, for dispensing the predetermined volume of the liquid, the control module 120 also computes the flow rate of the liquid discharged from the valve 114 in addition to computing the weight of the container 102, corresponding to the predetermined volume of the liquid to be dispensed. The flow rate may be measured by the control module 120 via the readings from the level sensor or by the results obtained from the trial test, or based on the pressure head of the liquid in the container 102. The control module operates the valve 114 towards the open position 210 and simultaneously computes the flow rate. Upon computing the flow rate corresponding to the particular pressure head of the liquid in the container 102, while monitoring the weight of the container 102, the control module 120 operates the valve 114 to the closed position 212 when the weight of the container 102 reaches or corresponds to the weight computed by the control module 120.

In an embodiment, the control module 120 is electronically coupled to an encoder 223 which in turn may be coupled to the actuator 208. The control module 120 is adapted to monitor actuation of the actuator 208 during operation of the valve 114. In an embodiment, for a rotary actuator, a rotary encoder 223 is coupled for determining the angular displacement of the rotary actuator 208.

In an exemplary embodiment, the control module 120 is configured with pre-defined computational data associated with specific actuators and valves, so that upon electronically coupling with such actuators and the valves, the control module 120, readily operates such actuators and valves for precisely dispensing the required volume of the liquid. In an embodiment, the control module 120 may be manually fed with pre-defined computation data based on the type of actuators and valve, for automating the dispensing process of the liquid.

Referring to FIG. 3, the flatbread making apparatus 300 configured to prepare flatbreads is illustrated. The flatbread making apparatus 300 includes the apparatus 100 for dispensing the liquid into the mixer unit 302. The apparatus 100 is configured to dispense the predetermined quantity of the liquid, based on an input received from the user. The input from the user may be one of a number of flatbreads to be prepared, a size of the doughball and the like. The mixer unit 302 is juxtaposed below the container 102 for receiving the predetermined volume of the liquid dispensed from the container 102. The mixer unit 302 also receives flour from a flour container 304. The mixer unit 302 kneads the predetermined volume and the flour to form a doughball. The doughball is further processed in a mechanism 306 of the flatbread making apparatus 300 for baking the flatbreads.

In an embodiment, the control module 120 in the apparatus 100 is configured to determine the level of the liquid prior to initiation of the liquid dispensing process in the flatbread apparatus 300, based on the input received from the user. In other words, if the user provides an input to prepare five flatbreads, the control module 120 determines the level of the liquid within the container 102 and confirms availability of the liquid for preparing the five flatbreads. If the liquid level is low, and can only accommodate a lesser number of flatbreads, for example, 3 flatbreads, the indication by either one of an audio means or a visual means may be provided to the user. In this scenario, the control module 120 may also enable dispensing of the liquid for baking the 3 flatbreads and thereafter pause the dispensing operation, due to lack of availability of the liquid. In an embodiment, the control module 120 provides an indication to the user 225 (for e.g. as shown in FIG. 2B) via a user interface of the mobile communication device 226 associated with the user 225. In an embodiment, the control module 120 provides the indication to the user via an application installed within the mobile phone 226 associated the user.

In an embodiment, the control module 120 also provides a method for determining the flow rate of the predetermined volume as well as the time at which dispensing of ingredients, particularly liquids should be stopped, based on power consumption by the flatbread making apparatus 300. In an exemplary embodiment, the control module measures the rotational speed of the mixer unit 302 at small, discrete intervals, and controls the power fed to the motor, which operates the mixer unit 302, to maintain the required rotational speed. The flow rate of the predetermined quantity of the liquid may be determined by computing the power or voltage of current consumption across the flatbread apparatus 302.

In an embodiment, an optical sensor 310 comprising an optical transmitter 310a and an optical receiver 310b are configured to determine the doughball consistency during mixing of the dough with the liquid. The optical sensor 310 monitors the mixing of the liquid particles with the dough, as dough during each iteration may require different volumes of liquid for mixing. In an embodiment, the volume of the liquid required for mixing with the dough may depend on the quality of the dough. In an embodiment, the initial reading stored within the control module 120 may be 25 gms of liquid for mixing 20 gms of dough, and accordingly, the control module 120 may initiate dispensing operation. In the process, the optical sensor monitors mixing of the dough with the liquid. If the optical sensor 310 detects complete mixing of the dough for 22 gms of the liquid, an indication is transmitted to the control module 120. The control module 120 accordingly stops the dispensing operation. The same process is applicable, when the dough is in need of greater quantity of water for mixing, than the pre-set value of the control module 120.

FIG. 4 in one exemplary embodiment of the present disclosure is a flow diagram illustrating a method 400 for dispensing the predetermined volume of the liquid via the apparatus 100. The method 400 depicted in the flow diagram may also be executed in the flatbread apparatus 300 of FIG. 3.

The control module 120 may determine the predetermined volume of the liquid based on the inputs received from the user. The inputs from the user may be the volume required to be dispensed which may be communicated to the control module 120 via the mobile communication device 226 associated with the user. In an embodiment, if the input received from the user is to dispense ‘100 ml’ of the liquid, the control module 120 directly considers the input as the predetermined volume and accordingly operates the apparatus 100 for dispensing the liquid. In an embodiment, if the input received from the user is to ‘prepare 1 flatbread’, the control module 120 based on the pre-defined computational values determines the volume required for preparing the doughball, and accordingly operates the apparatus 100 to dispense the required quantity of the liquid. Thus, the control module 120 processes the inputs received from the user suitably and accordingly determines the predetermined volume to be dispensed.

Upon determination of the predetermined volume of the liquid, the control module 120 subsequently confirms the availability of the liquid within the container 102. In an embodiment, if the predetermined volume of the liquid to be dispensed is determined to be ‘100 ml’, the control module 120 determines whether the container 102 is capable of dispensing ‘100 ml’, based on the weight of the container 102. The control module 120 proceeds further to operate the apparatus 100 when the required quantity of the liquid is stored in the container 102. The control module 120 provides the indication to the user when liquid quantity in the container 102 is lower than the predetermined volume.

Moreover, upon determination of the predetermined volume of the liquid, the control module 120 subsequently determines the flow rate of the liquid corresponding to the level of the liquid in the container and operates the valve 114 from open position 210 towards closed position 212 accordingly for dispensing the predetermined volume of the liquid.

At operation 402, the control module 120 computes the predetermined volume of the liquid configured to be dispensed via the plurality of modes. The predetermined volume of the liquid is computed based on the flow rate of the liquid dispensed from the valve 114, the weight of the container 102 measured by the load sensor 118. Upon computing the predetermined volume, the control module divides the predetermined volume, configured to be dispensed, into the first portion and the second portion. The division is computed by the control module 120, based on the flow rate of the liquid dispensed and the predetermined volume of the liquid. In an embodiment, the division is considered such that, the first portion has the maximum volume and the second portion has the minimum volume. The division of the predetermined volume is considered such that, the predetermined volume is dispensed accurately and precisely, while considerably reducing the time taken for the dispensing operation. In an embodiment, if the predetermined volume is 100 ml and the flow rate of the liquid is 5 ml/sec, the control module 120 may divide the first portion as 80 ml and the second portion as 20 ml. The control module 120 can also consider the weight of the container 102 or the liquid level for dividing the predetermined volume into the first portion and the second portion, as variation in the level or pressure head of the liquid varies the flow rate of the liquid. In this scenario, the control module 120 may continuously monitor the weight of the container 102 during the dispensing operation, for dispensing the predetermined volume precisely.

At operation 404, the control module operates the valve on time-based mode. In the time-based mode, the control module 120 determines the time duration required for dispensing the first portion of the predetermined volume. Accordingly, the control module 120 operates the valve 114 towards the opened position 210 for the computed predetermined duration of time for dispensing the first portion of the predetermined volume of the liquid. The control module 120 operates the valve 114 to fully opened position 210, so that the liquid is dispensed at a maximum flow rate. In an embodiment, if the first portion is 80 ml, the control module 120 determines the time duration required to be 14 seconds, at the rate of 5 ml/sec which is determined by the control module 120 prior to dispensing of the first portion. Accordingly, the control module 120 operates the valve 114 to the opened position 210 for 14 seconds for dispensing the first portion. Upon lapse of the predetermined duration of the time, the control module 120 operates the valve 114 to the closed position 212. The operation 404 may also be called as a rough stage dosing of the liquid or the time-based mode dispensing process for dispensing the first portion, due to its time-dependent operation. Additionally, as the first portion is discharged at the maximum flow rate, the time taken for dispensing the first portion is low.

In an embodiment, the control module 120 computes the variation in the flow rate of the liquid during the dispensing of the first portion. The control module 120 correspondingly adjusts operation of the valve for dispensing the first portion of the liquid.

At operation 406, the control module 120 operates the valve 114 on weight-based mode. In the weight-based mode dispensing, the control module 120 operates the valve 114 intermittently between the opened position 210 and the closed position 212 for dispensing the second portion of the predetermined volume of the liquid. The control module 120 may further divide the second portion into relatively smaller sub-portions, so that, each intermittent operation of the valve 114 dispenses the sub-portion. The control module 120 after each intermittent operation actuates the valve 114 to the closed position 212 for monitoring the weight of the container 102. This technique ensures that the second portion is accurately dispensed from the container 102. The second portion is dispensed intermittently from the container 102 due to its relatively lower volume when compared with the first portion. This configuration again provides greater control over the dispensing process and thus ensuring accurate and precise dispensing of the second portion. In an embodiment, if the second portion is 20 ml, the control module 120 may divide the second portion into five sub-portions, each sub-portion being 4 ml. Accordingly, the control module 120 operates the valve 114 to the opened position 210 for dispensing 4 ml of the liquid, while monitoring the weight of the container 102. Once 4 ml is dispensed, the dispensing operation is paused by the control module 120, for verifying the weight of the container 102. Upon confirming the weight of the container 102, the dispensing operation is resumed, in the same manner until 20 ml of the liquid is dispensed.

In an embodiment, the control module 120 may also include the variable sub-portions, such that the intervals of the valve 114 operating from the opened position 210 towards the closed position 212, reduces as the volume required to the dispensed decreases. In other words, the control module 120 may reduce the ratio of the interval of the valve 114 in the opened position 210 to the closed position 212, as the volume of the liquid to be dispensed decreases. In an embodiment, the control module 120 may divide the second portion into four sub-portions as 8 ml, 6 ml, 4 ml, and 2 ml. Accordingly, the control module 120 monitors the valve 114 to the opened position 210 for dispensing 8 ml of the liquid, while monitoring the weight of the container 102. Subsequently, the dispensing operation is paused by the control module 120 for verifying the weight of the container 102. Upon verification, the control module 120 resumes the operations in the same manner, until each of the 6 ml, 4 ml, and 2 ml of the liquid is dispensed in subsequent intermittent process. As the volume is reduced in each sub-portion, the ratio of the time required for the valve 114 to be in the opened position 210 and the closed position 212 reduces. This operation 406 called as weight-based mode, is the intermittent step and provides the maximum control over the dispensing process. Additionally, due to the stop and start analogy used in the operation 406, the error readings which may be induced due to mechanical vibrations or any other factors may be eliminated.

Various example embodiments of the present disclosure described herein, with reference to various schematic views and flow diagrams, are for illustrative purposes and provided numerous advantages and technical effects. For instance, the apparatus is configured to scatter the powdered material while dispensing, thereby preventing dispensing of chunks of the powdered material. The prevention of dispensing of chunks inherently improves the accuracy and precision of dispensing of the powdered material. Additionally, the apparatus is scalable, modular and inexpensive.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims.

What is claimed is:

1. An apparatus for dispensing liquid, comprising:
a container for storing the liquid, the container comprising an inlet for receiving the liquid and an outlet for dispensing the liquid;
a valve mounted to the outlet and operable between an opened position and a closed position for regulating flow of the liquid routed through the outlet;
a load sensor adapted to support the container for measuring weight of the container; and
a control module adapted to control operation of the valve between the opened position and the closed position for dispensing a predetermined volume of the liquid from the container in a plurality of modes based on readings obtained from the load sensor and a predetermined duration of time determined by the control module.

2. The apparatus as claimed in claim 1, wherein the valve in the opened position allows dispensing of the liquid from the container, and the valve in the closed position restricts dispensing of the liquid from the container.

3. The apparatus as claimed in claim 1, wherein the control module is configured to compute the predetermined volume of the liquid to be dispensed, and to divide the predetermined volume into a first portion and a second portion,
wherein in a time-based mode of the plurality of modes, the first portion is dispensed, by operating the valve to the opened position for the predetermined duration of time and operating the valve to the closed position upon lapse of the predetermined duration of time; and
wherein in a weight-based mode of the plurality of modes, the second portion is dispensed by operating the valve between the opened position and the closed position intermittently, the control module monitoring the weight of the container while dispensing sub-portions during each intermittent operation of the valve and correspondingly adjust intermittent operation of the valve for dispensing the second portion.

4. The apparatus as claimed in claim 3, wherein the control module is configured to compute the first portion and the second portion based on a flow rate of the liquid from the valve, the weight of the container measured by the load sensor and the predetermined volume required to be dispensed.

5. The apparatus as claimed in claim 4, wherein the control module computes the predetermined duration of time, based on the flow rate of the liquid dispensed and the weight of the container corresponding to the first portion of the liquid to be dispensed.

6. The apparatus as claimed in claim 1, wherein the load sensor is configured to monitor level of the liquid within the container based on the weight of the container, and wherein the load sensor is configured to provide an indication signal to the control module when the level of the liquid is below a threshold level in the container.

7. A flatbread making apparatus, comprising:
an apparatus for dispensing a liquid, comprising:
a container for storing the liquid, the container comprising an inlet for receiving the liquid and an outlet for dispensing the liquid,
a valve mounted to the outlet and operable between an opened position and a closed position for regulating flow of the liquid routed through the outlet,
a load sensor adapted to support the container for measuring weight of the container, and
a control module adapted to control operation of the valve between the opened position and the closed position for dispensing a predetermined volume of the liquid from the container in a plurality of modes based on readings obtained from the load sensor and a predetermined duration of time determined by the control module;
a mixer unit juxtaposed below the container, the mixer unit configured to receive the predetermined volume of the liquid dispensed from the container, the mixer unit adapted to knead flour with the predetermined volume of the liquid for preparing a doughball; and
a mechanism to bake a flatbread from the doughball received from the mixer unit.

8. The flatbread making apparatus as claimed in claim 7,
wherein the control module is configured to compute the predetermined volume of the liquid to be dispensed, and to divide the predetermined volume into a first portion and a second portion;
wherein in a time-based mode of the plurality of modes, the first portion is dispensed, by operating the valve to the opened position for the predetermined duration of time and operating the valve to the closed position upon lapse of the predetermined duration of time; and
wherein in a weight-based mode of the plurality of modes, the second portion is dispensed by operating the valve between the opened position and the closed position intermittently, the control module monitoring the weight of the container while dispensing sub-portions during each intermittent operation of the valve and correspondingly adjust intermittent operation of the valve for dispensing the second portion.

9. The flatbread making apparatus as claimed in claim 8, wherein the load sensor is configured to monitor level of the liquid within the container based on the weight of the container, and wherein the load sensor is configured to provide an indication signal to the control module when the level of the liquid is below a threshold level in the container.

10. A method for dispensing a liquid, comprising:
computing, by a control module, a predetermined volume of the liquid to be dispensed via a plurality of modes, wherein the control module computes the predetermined volume of the liquid based on a flow rate of the liquid dispensed from a valve of a container, weight of the container measured by a load sensor;
dividing, by the control module, the predetermined volume of the liquid to be dispensed into a first portion and a second portion;
operating, by the control module, the valve to an opened position in a time-based mode, for a predetermined duration of time for dispensing the first portion and to a closed position upon lapse of the predetermined duration of time, wherein the control module computes the predetermined duration of time, based on the flow rate of the liquid dispensed and the weight of the container corresponding to the first portion of the liquid to be dispensed; and
operating, by the control module, the valve between the opened position and the closed position intermittently in a weight-based mode, for dispensing the second portion, wherein the control module monitors the weight of the container while dispensing sub-portions of the second portion during each intermittent operation of the valve and correspondingly adjusting the intermittent operation of the valve for dispensing the second portion.
